(19) United States
(12) Patent Application Publication
(10) Pub. No.: US 2007/0062762 A1
(43) Pub. Date: Mar. 22, 2007

(54) Elevator installation with drivebelt pulley and flat-beltlike suspension means

(76) Inventor: Ernst Ach, Ebikon (CH)

Correspondence Address: Klaus P. Stoffel;Wolff & Samson PC, One Boland Drive, West Orange, NJ, 07052, US

(21) Appl. No.: 11/521,658

(22) Filed: Sep. 15, 2006

(30) Foreign Application Priority Data
Sep. 20, 2005 (EP) 05108680.9

(51) Int. Cl. B66B 11/08

(52) U.S. Cl. 187/266

(57) ABSTRACT

An elevator installation with a drivebelt sheave and a flat-beltlike suspension member that bears the elevator car and the counterweight, and that is driven by the drivebelt sheave. A running surface or a partial running surface of the drivebelt sheave, via which the flat-beltlike suspension member rests on the drivebelt sheave, is friction-reducingly coated or friction-reducingly surface treated.

### BACKGROUND OF THE INVENTION

The invention relates to an elevator installation with an elevator car, a drivebelt pulley, and a flat-beltlike suspension means, the flat-beltlike suspension means bearing the elevator car and the counterweight and being driven by the drivebelt pulley.

From EP 1 169 256 B1 a drivebelt pulley for driving several flat-beltlike suspension means of an elevator installation that are arranged in parallel is known, whose running surfaces have a surface roughness, measured in the direction of their circumference, of 1 μm to 3 μm (micrometers) so as to assure greater and defined tractive capacity of the elevator drive. According to one of the published embodiments, the running surfaces of the drivebelt pulley, i.e. those surface parts of the drivebelt pulley that radially bear, and by means of friction, drive, the flat-beltlike suspension means, are provided with a corrosion-resistant and wear-resistant surface coating whose surface roughness corresponds with the aforesaid values.

In certain cases of application, the application of such a drivebelt pulley is associated with disadvantages and problems. If it is used to drive flat-beltlike suspension means that have a belt sheath of rubber, or of a suitable elastic plastic, this results in an excessively high tractive capacity between the drivebelt traction sheave and the suspension means, since the coefficient of friction between metallic sheave materials and the aforesaid materials of the belt sheath is substantially higher than the coefficient of friction between steel-wire ropes and metallic rope sheaves. This can cause functional and safety problems in the operation of an elevator installation with a counterweight. There is, for example, the risk that the elevator car can still be raised further upwards by the drivebelt pulley and the suspension means if the counterweight is stopped by its lower striking buffer as a result of a control fault. In practice, such a situation can cause a free fall of the car if, after a certain raising distance, the tractive force between the drivebelt pulley and the suspension means is largely removed as a result of the missing counterweight force. Moreover, the high tractive capacity that arises in elevator installations with several strands of suspension means arranged in parallel prevents load equalization between the individual strands of the suspension means from already occurring at small differences in load. Damaging overloads in individual strands of suspension means can thereby result.

In a drive arrangement according to EP 1 169 256 B1 with a beltlike suspension means and a drivebelt sheave that act in conjunction over running surfaces without guide grooves and guide ribs, a high friction between the drivebelt sheave and the flat belt that is not absolutely necessary for traction also has the consequence that the lateral guidance of the flat belt on the belt sheave, which is usually effected with the aid of lateral sheave flanges and/or by lateral arched running surfaces of the belt sheave, fails, since these methods of belt guidance always depend on a gliding process between the flat belt and the belt sheave.

### SUMMARY OF THE INVENTION

The object of the present invention is to provide an elevator installation of the type stated at the outset that does not have the stated disadvantages of an elevator installation in which the tractive capacity between the drivebelt sheave and flat-beltlike suspension means is higher than absolutely necessary for safe elevator operation. In particular, an elevator installation is provided in which the elevator car cannot be raised further by the flat-beltlike suspension means if the counterweight is resting on its lower striking buffer and in which a load equalization between several strands of suspension means can be assured with greater certainty and in which the lateral guidance of the flat-beltlike suspension means on the drivebelt sheave is less problematical.

With flat-beltlike suspension means and drivebelt sheaves that, for the purpose of safer lateral guidance of the suspension means, are provided with, for example, V-shaped ribs and grooves, the problems with raising the car when the counterweight is blocked, and with insufficient load equalization, occur with greater intensity. The reason for this is that the wedge effect that occurs between the rib flanks of the suspension means and the groove flanks of the drivebelt sheave causes a substantial increase in the tractive force that can be transmitted.

According to the invention, the object is fulfilled in that, in an elevator installation that contains at least one drivebelt sheave and at least one flat-beltlike suspension means that bears the elevator car and the counterweight, and by means of which the drivebelt sheave is driven, at least one running surface of the drivebelt sheave over which the suspension means runs, and on which it supports itself radially, is provided with a friction-reducing coating or subjected to a friction-reducing surface treatment.

Hereinafter, “friction-reducing” describes coatings and surface treatments of a running surface of the drivebelt sheave that have the consequence that the coated or surface-treated running surface has a lower coefficient of friction relative to the flat-beltlike suspension means than the material of the body of the drivebelt sheave.

The invention is accordingly based on the idea of eliminating the aforementioned disadvantages and problems, that occur in connection with flat-beltlike suspension means of rubber or elastic plastics as a consequence of excessive friction between suspension means and drivebelt sheaves, by providing the running surfaces of the drivebelt shaves with friction-reducing coatings or subjecting them to a friction-reducing surface treatment.

The advantages achieved by means of the invention are mainly to be seen in that
the risk that the elevator car can still be raised further upwards by the drive and the suspension means, if the counterweight is stopped by its lower striking buffer as a result of a control fault, is practically eliminated;
there is greater assurance of a necessary equalization between the loading forces of the individual strands of suspension means; and
the problems with the lateral guidance of the flat-beltlike suspension means on the drivebelt sheaves, caused by greater friction between the drivebelt sheave and the suspension means, are reduced.

Advantageous embodiments and further developments of the invention are described below.

In another embodiment of the elevator installation according to the invention, a sheath of an elastic plastic, or of rubber, and with an essentially rectangular cross section, surrounds the flat-beltlike suspension means. Suspension means in the form of steel wires, fiber strands, or flat fiber fabric are embedded in the sheath.

An excellent lateral guidance of the suspension means on the drivebelt sheave is achieved in an elevator installation according to the invention in which
the flat-beltlike suspension means has, in the area of its running surface, ribs and grooves that extend in the lengthwise direction of the suspension means;
at its periphery, the drivebelt sheave has ribs and grooves that extend in the direction of the circumference of the drivebelt sheave; and
the cross section through the ribs and grooves of the suspension means, or of the drivebelt sheave, have external contours that are at least partially mutually complementary.

An outstandingly quiet running of the flat-beltlike suspension means results from an embodiment of the invention in which, between the ribs and grooves of the drivebelt sheave and the ribs and grooves of the suspension means, partial running surfaces are present via which the suspension means rests on the drivebelt sheave. At least part of this partial running surface is arranged neither cylindrically nor perpendicular to an axis of rotation of the drivebelt sheave. The term “partial running surfaces” is to be understood as individual contact surfaces between a drivebelt sheave and a flat-beltlike suspension means that are present as a result of a profiling of the drivebelt sheave and the corresponding suspension means.

According to a preferred embodiment of the invention, the ribs and grooves of the flat-beltlike suspension means have V-shaped or trapezoid cross sections.

The best possible running properties of the suspension means are attained, even with faulty mutual alignment of drivebelt sheave and suspension means, if the flat-beltlike suspension means is a poly-V belt that has a plurality of laterally contiguous ribs and grooves with V-shaped cross section.

It is advantageous for the running surfaces of the drivebelt sheave, via which the suspension means rest on the drivebelt sheave, to have in at least partial areas a chrome coating, as a result of which the tractive force attainable between suspension means and drivebelt sheave is reduced.

In an elevator installation according to the invention, outstanding wear-resistance as well as low and especially stable coefficients of friction between the drivebelt sheave and the suspension means are attainable if the chrome coating is a chrome coating that is created galvanically by the Topochrome process and whose surface displays dome-shaped microstructures.

Expedient solutions to the problem of excessively high coefficients of friction between the drivebelt sheave and suspension means can also be obtained through the running surfaces of the drivebelt sheave, via which the suspension means rest radially on the drivebelt sheave, having at least in partial areas one of the following sorts of friction-reducing coatings or surface treatments:
coating of amorphous carbon, known as DLC (diamond-like carbon)
Teflon® coating
ceramic coating
carbo-nitride oxidation as surface treatment.

The lowest possible noise generation and vibration-free running of the flat-beltlike suspension means is obtained in elevator installations in which the running surfaces, or partial running surfaces, of the suspension-means diverter pulleys are friction-reducingly coated or friction-reducingly surface treated.

Other features and advantages of the present invention will become apparent from the following description of the invention that refers to the accompanying drawings.

### BRIEF DESCRIPTION OF THE DRAWINGS

FIG. 1 is a cross-section of a drivebelt sheave with slightly arched running surfaces for several flat-beltlike suspension means;

FIG. 2 shows a drivebelt sheave on which rest suspension means, the running surfaces of the drivebelt sheave, and of the suspension means, having ribs and grooves that extend in the circumferential direction, or in the lengthwise direction, of the suspension means;

FIG. 3 shows a drivebelt sheave on which rest suspension means, the drivebelt sheave as well as the suspension means having ribs and grooves with trapezoid cross section;

FIG. 4 shows a drivebelt sheave with a poly-V belt as suspension means;

FIG. 5 is a diagrammatic, greatly enlarged section through a running surface of a drivebelt sheave that is coated by the Topochrome process; and

FIG. 6 is a diagrammatic, greatly enlarged view of the surface of a running surface of a drivebelt sheave that is coated by the Topochrome process.

### DETAILED DESCRIPTION OF THE INVENTION

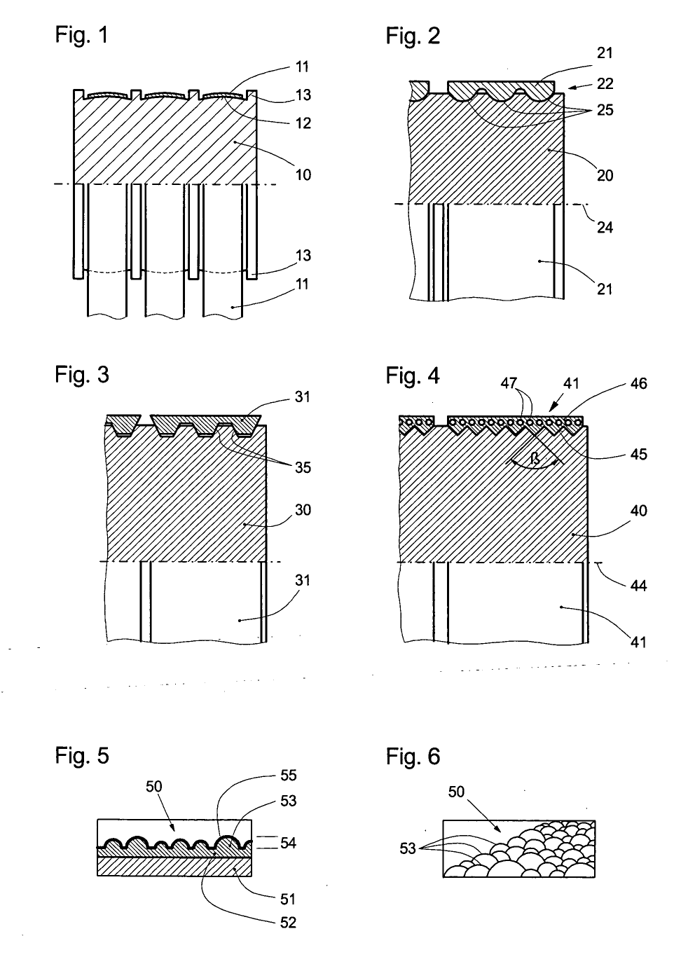

Shown in FIG. 1 is a drivebelt sheave 10 with several flat-beltlike suspension means or members 11. The running surfaces 12 of the drivebelt sheave 10 are slightly arched perpendicular to the circumferential direction, as a result of which a certain self-centering of the suspension means 11 in the middle of the respective running surface 12 is attainable. The centering effect depends inter alia on the magnitude of the coefficient of friction between the suspension means 11 and the running surfaces 12 of the drivebelt sheave 10, i.e. a high coefficient of friction hinders an optimal centering effect of the running-surface arching. To obtain best possible self-centering of the suspension means 11 on the drivebelt sheave 10, but also to prevent the aforesaid dangerous raising of the elevator car with blocked counterweight, and to ensure load equalization between the suspension means 11, the running surfaces 12 are friction-reducing coated or friction-reducing surface treated. Different possibilities for realizing such a coating or surface treatment are discussed later.

The drivebelt sheave 10 shown in FIG. 1 is also provided with several sheave flanges 13 that form an additional means of ensuring that, during operation of the elevator, the flat-beltlike suspension means 11 remains centered on the running surface 12 assigned to it.

Drivebelt sheaves of the type shown in FIG. 1 require a precise mutual alignment of all belt sheaves involved in driving and diverting the flat-beltlike suspension means. Should such alignment be insufficiently precise, the flat-beltlike suspension means 11 rubs with its side surfaces against the sheave flanges 13 which, through abrasion, or through the side area of the suspension means 11 climbing up a sheave flange 13, can cause destruction of the suspension means. The choice of lowest possible coefficients of friction between the running surfaces of the drivebelt sheave and the suspension means that are still sufficient to ensure the function of traction transmission, can have a decisive positive influence on the life of the suspension means. It is advantageous for the sheave flange 13 of the drivebelt sheave 10 to be friction-reducingly coated or treated.

It is expedient for the running surfaces and/or the sheave flanges of diverter pulleys of an elevator installation also to be friction-reducingly coated or treated, so as to attain a best-possible centering of the suspension means on their running surfaces, as well as a vibration-free quiet running of the suspension means, and thereby to keep the wear of the suspension means as low as possible. This applies particularly to diverter pulleys that have ribs and grooves in the circumferential direction, so as to laterally guide suspension means with at least partially complementarily formed ribs and grooves as described below.

FIG. 2 shows a drivebelt sheave 20 that has resting on it a flat-beltlike suspension means 21 whose running surfaces 22 have ribs and grooves that extend in the circumferential direction of the drivebelt sheave 20, or in lengthwise direction of the suspension means 21. It is possible for the ribs and grooves to have virtually any cross-sectional form. The purpose of these ribs and grooves is to guide the suspension means 21 on the drivebelt sheave 20 without great accuracy of the mutual alignment of the belt sheaves and suspension means being necessary. The ribs and grooves of the drivebelt sheave 20 are formed at least in partial areas complementary to the ribs and grooves of the suspension means 21, these partial areas forming partial running surfaces 25 via which the suspension means rests on the drivebelt sheave 20. A substantial part of the partial running surfaces 25 is not cylindrical relative to the axis of rotation 24 of the drivebelt sheave but arranged at an angle to this axis of rotation. Since a significant part of the radial forces occurring between the drivebelt sheave 20 and the suspension means 21 is transmitted via such sloping parts of the partial running surfaces 25, a sort of wedge effect results in increased tractive capacity between the drivebelt sheave 20 and the suspension means 21. The procedure for increasing the tractive capacity is known from the use of V-belts. To avoid the disadvantages of an increase in tractive capacity described in the introduction, according to the invention, the running surfaces 22 or partial running surfaces 25 respectively of the drivebelt sheave are friction-reducingly coated or friction-reducingly surface treated.

FIG. 3 shows a further embodiment of a drivebelt sheave 30 on which rests a flat-beltlike suspension means 31, the sheave as well as the suspension means having ribs and grooves with trapezoid cross section. To obtain quiet running and certain lateral guidance of the suspension means 31 on the drivebelt sheave 30, the suspension means rests via the diagonal side flanks of its trapezoid ribs on the corresponding diagonal flanks of the grooves of the drivebelt sheave on the drivebelt sheave. Here, the diagonal flanks form several partial running surfaces 35. Also in this embodiment, as a consequence of the wedge effect between the ribs of the suspension means and the grooves of the drivebelt sheave, there results an increase in the tractive capacity. To avoid the disadvantages of this increase in tractive capacity, according to the invention, at least the diagonal flanks 35 of the grooves of the drivebelt sheave 30 that form the several partial running surfaces are friction-reducingly coated or friction-reducingly surface treated.

FIG. 4 shows an embodiment of a drivebelt sheave 40 and of a flat-beltlike suspension means 41 belonging to it, in which the drivebelt sheave and the suspension means have ribs and grooves with essentially triangualar cross section. The sheath 46 of the flat-beltlike suspension means consists of rubber or of an elastic plastic, preferably of polyurethane or EPDM (ethylene-propylene terpolymer). Visible in the cross section of the suspension means that is shown are round tension reinforcers 47 that can consist of, for example, steel-wire strands or artificial-fiber strands. The embodiment of the flat-beltlike suspension means 41 shown here, that is known as a poly-V belt, is characterized by outstandingly quiet running and can be guided safely without problem, and with little wear, on the belt sheaves of the elevator installation, even with relatively imprecise mutual alignment of the belt sheaves of the elevator installation and the suspension means. Good operating characteristics are obtained with poly-V belts whose wedge angle β lies between 60° and 120°, optimal results being obtained with wedge angles of 80° to 100°. Also in this embodiment of the drivebelt sheave and flat-beltlike suspension means, the suspension means 41 rests via diagonal flanks, i.e. via partial running surfaces 45 arranged diagonal to the axis of rotation 44 of the drivebelt sheave 40, on the drivebelt sheave 40. This results, on the one hand, in the excellent running and guidance characteristics of this suspension means arrangement and, on the other hand, in the known increase in tractive capacity with the aforesaid disadvantages. Smaller values of the wedge angle β yield better characteristics in relation to the lateral guidance of the suspension means on the drivebelt sheave, but they cause a substantial increase in the tractive capacity between the drivebelt sheave and the suspension means. To avoid the disadvantages of the increased tractive capacity, the triangular shaped ribs and grooves of the drivebelt sheave are friction-reducingly coated or friction-reducingly surface treated.

FIG. 5 shows a greatly enlarged cross section through a running surface 50, or partial running surface, of a drivebelt sheave according to the invention that has been friction-reducingly coated by the Topochrome process, and FIG. 6 shows a greatly enlarged view of the surface of such a running surface, or partial running surface, coated by the Topochrome process.

The Topochrome coating is a chrome layer that is galvanically applied to a base material 51 (drivebelt sheave 10, 20, 30, 40) in which dome-shaped microstructures 53 that grow out of a basic chrome layer 52 form a structure layer 54 that is covered by a thin final layer 55 (of chrome). The formation of the dome-shaped microstructures 53, with diameters of typically less than 0.1 mm, is effected by suitable manipulation of the process parameters (current intensity, temperature, speed of flow of the electrolyte) during the galvanic coating process.

By comparison with processed metal surfaces, or with other galvanically coated surfaces, gliding friction between one friction body and another friction body whose surface has the aforementioned dome-shaped microstructures results in a greatly reduced coefficient of friction. Thanks to the large proportion of supporting microstructure surfaces in the overall surface, the coated friction body, i.e. in the present case the running surface of a drivebelt sheave or of a diverter sheave, also has outstanding wear resistance.

Self-evidently, other processes are also suitable for the friction-reducing coating or friction-reducing surface treatment of drivebelt sheaves in elevator installations according to the invention. Examples of such processes are
coating of amorphous carbon, known as DLC (diamond-like carbon),
Teflon® coating,
ceramic coating, and
carbo-nitride oxidation as surface treatment.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. An elevator installation, comprising: an elevator car; a drivebelt sheave, and at least one flat-beltlike suspension means that is driven by the drivebelt sheave and bears and moves the elevator car, at least a portion of a running surface of the drivebelt sheave, via which the flat-beltlike suspension means rests on the drivebelt sheave, being friction-reducingly coated or friction-reducingly surface treated.

2. The elevator installation according to claim 1, wherein the flat-beltlike suspension means includes a sheath of an elastic plastic or of rubber with an essentially rectangular cross section, tension means being embedded in the sheath.

3. The elevator installation according to claim 2, wherein the tension means are one of the group consisting of steel wire, fiber strands and flat fiber fabrics.

4. The elevator installation according to claim 1, wherein the flat-beltlike suspension means has, in an area of the running surface, ribs and grooves that extend in a lengthwise direction of the suspension means, the drivebelt sheave having a periphery with ribs and grooves that extend in a direction of the circumference of the drivebelt sheave, and cross sections through the ribs and grooves of the suspension means and cross sections of the drivebelt sheave having external contours that are at least partially mutually complementary.

5. Elevator installation according to claim 4, wherein between the ribs and grooves of the drivebelt sheave and the ribs and grooves of the flat-beltlike suspension means, partial running surfaces are present via which the suspension means rest on the drivebelt sheave, at least part of the partial running surfaces being arranged neither cylindrically nor perpendicular to an axis of rotation of the drivebelt sheave

6. The elevator installation according to claim 5, wherein the ribs and grooves of the flat-beltlike suspension means, and of the drivebelt sheave, have V-shaped or trapezoid cross sections.

7. The elevator installation according to claim 5, wherein, the flat-beltlike suspension means has a plurality of laterally mutually contiguous ribs and grooves with V-shaped or triangular cross section.

8. The elevator installation according to claim 1, and further comprising a diverter pulley for the suspension means, the diverter pulley having a running surface, at least a portion of the running surface of the diverter pulley being friction-reducingly coated or friction-reducingly surface treated.

9. A drivebelt sheave for driving a flat-beltlike suspension means of an elevator installation, comprising a running surface, at least a portion of the running surface, via which the flat-beltlike suspension means rests on the drivebelt sheave, being, at least in partial areas, friction-reducingly coated or friction-reducingly surface treated.

10. The drivebelt sheave according to claim 9, wherein the at least a portion of the running surface has a chrome coating at least in partial areas.

11. The drivebelt sheave according to claim 10, wherein the chrome coating is a chrome coating that is galvanically created by the Topochrome process and whose surface has dome-shaped microstructures.

12. The drivebelt sheave according to claim 9, wherein the at least a portion of the running surface has at least in partial areas a friction-reducing coating or surface treatment selected from the group consisting of:
a coating of amorphous carbon, known as DLC (diamond-like carbon),
a Teflon® coating,
a ceramic coating, and
a carbo-nitride oxidation as a surface treatment.
